(19) United States
(12) Patent Application Publication
(10) Pub. No.: US 2026/0195732 A1
(43) Pub. Date: Jul. 9, 2026

(54) SECURE IN-VEHICLE COMMUNICATION FOR OFFLINE SERVICE USING GENERATIVE ARTIFICIAL INTELLIGENCE AND LIGHT FIDELITY (LI-FI)

(71) Applicant: International Business Machines Corporation, Armonk, NY (US)

(72) Inventors: Ahamed Jalaldeen SHAHUL HAMID, Bangalore (IN); Santosh RAJASHEKAR, Bangalore (IN); Selvi JOHN, Bangalore (IN)

(21) Appl. No.: 19/011,777

(22) Filed: Jan. 7, 2025

(51) Int. Cl. G06Q 20/32; B60K 35/10; B60K 35/28; G06Q 20/38; H04B 10/116

(52) U.S. Cl. CPC G06Q 20/327; B60K 35/10; B60K 35/28; G06Q 20/382; H04B 10/116

(57) ABSTRACT

Methods and apparatus are provided for securing in-vehicle payments for offline services using generative AI and Li-Fi communication. A Li-Fi payment assistant unit of a vehicle is activated in response to the vehicle being within a defined range of a service station. Once activated, the Li-Fi payment assistant receives payment transaction information via an input device within the vehicle, encrypts the payment transaction information, identifies a Li-Fi protocol used by the service station for communication, transforms the encrypted payment transaction information from a payment message format to a Li-Fi protocol format compatible with the identified Li-Fi protocol, encodes the transformed payment transaction information into a light signal by modulating light emitted from one or more light sources of the vehicle, and transmits the light signal to the service station.

### BACKGROUND

The present disclosure relates to in-vehicle communication, and more specifically, to securing in-vehicle data transaction for offline services using generative artificial intelligence (AI) and Light Fidelity (Li-Fi) communication.

There has been a significant rise in the volume of in-vehicle payments, particularly for offline services such as fuel or EV charging, or car washes. Several factors contribute to this increasing trend. Accessibility and safety concerns are one reason, especially when service stations are located in remote or isolated areas where it may be unsafe or inconvenient for drivers to open their vehicle windows or leave their vehicles to manually complete payments. Extreme weather conditions, such as freezing temperatures and hot weather, long waiting times caused by manual payment methods, and issues with internet connectivity or bandwidth that occur in remote areas further highlight the need for streamlined in-vehicle payment solutions. In addition, space constraints at service stations further complicate leaving the vehicles for longer period for manual payments, and the mobility challenges faced by seniors and individuals with disabilities make in-vehicle payments an increasingly attractive option.

### SUMMARY

One embodiment presented in this disclosure provides a method, including activating a generative artificial intelligence-based Light Fidelity (Li-Fi) payment assistant unit of a vehicle in response to a user input, receiving payment transaction information via an input device within the vehicle, encrypting the payment transaction information, identifying a Li-Fi protocol used by the service station for communication, transforming the encrypted payment transaction information from a payment message format to a Li-Fi protocol format compatible with the identified Li-Fi protocol, encoding the transformed payment transaction information into a light signal by modulating light emitted from one or more light sources of the vehicle, and transmitting the light signal to the service station.

One embodiment presented in this disclosure provides a method, including receiving, by a Li-Fi payment assistant unit of a service station, a light signal containing a payment message from a vehicle, transforming the payment message from a Li-Fi protocol format to a payment message format, where the Li-Fi protocol format is compatible with a Li-Fi protocol used by the service station for communication, decrypting the payment message to retrieve payment transaction information, executing the payment transaction information by communicating with one or more external networks via a payment gateway, and generating a payment acknowledgment based on a result of the execution.

Other embodiments in this disclosure provide systems comprising one or more processors and one or more memories storing a program, which, when executed on any combination of the one or more processors, perform operations in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example environment for in-vehicle payments for offline services using Li-Fi communication and generative artificial intelligence, according to some embodiments of the present disclosure.

FIG. 3 depicts an example workflow for authorizing and transmitting payment information from a vehicle to a service station via Li-Fi, according to some embodiments of the present disclosure.

FIG. 4 depicts an example workflow for processing and transmitting payment acknowledgment information from a service station to a vehicle using Li-Fi communication, according to some embodiments of the present disclosure.

FIGS. 5A and 5B depict an example method for a vehicle authorizing and transmitting payment transaction information to a service station using Li-Fi payment assistant, according to some embodiments of the present disclosure.

FIGS. 6A and 6B depict an example method for a service station processing and transmitting payment acknowledgment information to a vehicle using Li-Fi payment assistant, according to some embodiments of the present disclosure.

FIG. 7 depicts an example method for drive interaction with the Li-Fi payment assistant, according to some embodiments of the present disclosure.

FIG. 8 is a flow diagram depicting an example method for in-vehicle Li-Fi payment processing, according to some embodiments of the present disclosure.

FIG. 9 is a flow diagram depicting an example method for Li-Fi payment processing at a service station, according to some embodiments of the present disclosure.

FIG. 10 depicts an example computing device configured to perform various aspects of the present disclosure, according to some embodiments of the present disclosure.

FIG. 11 depicts an example computing device configured to perform various aspects of the present disclosure, according to some embodiments of the present disclosure.

### DETAILED DESCRIPTION

One embodiment presented in this disclosure provides a computer-implemented method, including activating a generative artificial intelligence-based Light Fidelity (Li-Fi) payment assistant unit of a vehicle in response to a user input, receiving payment transaction information via an input device within the vehicle, encrypting the payment transaction information, identifying a Li-Fi protocol used by the service station for communication, transforming the encrypted payment transaction information from a payment message format to a Li-Fi protocol format compatible with the identified Li-Fi protocol, encoding the transformed payment transaction information into a light signal by modulating light emitted from one or more light sources of the vehicle, and transmitting the light signal to the service station. The disclosed embodiment provides a secure and streamlined approach to communicating payment transaction information from a vehicle to a service station via Li-Fi technology and generative artificial intelligence. The disclosed approach maintains compatibility between the vehicle and the service station's communication protocols and enables encrypted transmission of payment data through the vehicle's existing light sources.

In one embodiment, the method further includes receiving a light signal containing an encrypted payment acknowledgement from the service station, transforming the encrypted payment acknowledgement from the Li-Fi protocol format into the payment message format, decrypting the encrypted payment acknowledgement to retrieve payment status information, presenting the payment status information via a user interface within the vehicle, and deactivating the Li-Fi communication system in response to a second user input or a completion of payment. The disclosed embodiment provides a secure and streamlined approach for a vehicle to process encrypted payment acknowledgments received from a service station via Li-Fi technology. The disclosed approach maintains compatibility between the vehicle and the service station's communication protocols, enables the decryption of the acknowledgment to retrieve payment status information, and facilitates the display of payment status information within the vehicle.

In one embodiment, the payment status information may be presented as a voice output, a text output, or a combination thereof. The disclosed embodiment provides the option to present or display the payment status information via a voice output, a text output, or a combination of both. This approach further improves the system's accessibility and allows the users (e.g., drivers or passengers) to receive payment updates in a manner that suits their preferences or driving conditions.

In one embodiment, the encryption of the payment transaction information may be performed using a hardware-based encryption module and an encryption algorithm. The disclosed embodiment provides a secure approach for message encryption. The use of hardware-based encryption offers improved performance and reliability compared to software-based solutions and, therefore, enhances the overall security of the in-vehicle payment system.

In one embodiment, the input device may be selected from the group consisting of a fingerprint scanner, a camera with facial recognition functionality, or a card-based reader. The disclosed embodiment allows the Li-Fi payment assistant unit to receive biometric data (e.g., fingerprint, facial recognition data) and payment credentials (e.g., physical card information, digital wallet details, bank account information, or quick response (QR) codes) for authorization from various sources, such as a fingerprint scanner, a camera with facial recognition functionality, and a card-based reader. By supporting these diverse input options, the embodiment increases the convenience for drivers while maintaining a high level of security.

In one embodiment, the one or more light sources of the vehicle may be selected from the group consisting of a headlight of the vehicle, a daytime running light (DRL) of the vehicle, or a fog light of the vehicle. The disclosed embodiment uses these existing light sources, allowing the vehicle to perform Li-Fi communication for payment transactions without requiring significant modifications to its design or infrastructure.

In one embodiment, the method may further include integrating a foundation model into the Li-Fi payment assistant unit of the vehicle, generating a vehicle-specific Li-Fi payment model by fine-tuning the foundation model to accommodate one or more vehicle-specific Li-Fi payment requirements, applying the vehicle-specific Li-Fi payment model to identify the Li-Fi protocol used by the service station for communication, refining the vehicle-specific Li-Fi payment model using data related to the identified Li-Fi protocol, and applying the refined vehicle-specific Li-Fi payment model to transform the encrypted payment transaction information from a payment message format to the Li-Fi protocol format. The disclosed embodiment introduces the use of generative AI for protocol identification, message format transformation and hardware-based encryption. The AI-driven approach simplifies the message format transformation process and improves the system's capability to handle secure, diverse communication standards without manual intervention.

Additionally, or alternatively, in one embodiment, the one or more light sources of the vehicle may be selected from the group consisting of a headlight of the vehicle, a daytime running light (DRL) of the vehicle, or a fog light of the vehicle, and the method may further include receiving a light signal containing an encrypted payment acknowledgement from the service station, transforming the encrypted payment acknowledgement from the Li-Fi protocol format into the payment message format, decrypting the encrypted payment acknowledgement to retrieve payment status information, and presenting the payment status information via a user interface within the vehicle. The disclosed embodiment may be useful for upgrading existing vehicles with Li-Fi capabilities, which enables these vehicles to use existing hardware to exchange Li-Fi messages without requiring significant structure or electrical modification. An example scenario for this embodiment is in vehicles that lack pre-installed Li-Fi-specific hardware but require a cost-effective and efficient solution for enabling Li-Fi communication.

Additionally, or alternatively, in one embodiment, the method may further include receiving a light signal containing an encrypted payment acknowledgement from the service station, transforming and decrypting the encrypted payment acknowledgement to retrieve payment status information, and presenting the payment status information via a user interface within the vehicle, where the payment status information is presented as a voice output, a text output, or a combination thereof. The disclosed embodiment has the technical effects of enabling Li-Fi communication and enhancing the system's accessibility. The voice output is particularly beneficial in scenarios where the driver's visual attention is focused on the road, while the text output allows for detailed payment information to be reviewed at convenience.

One embodiment presented in this disclosure provides a method, including receiving, by a Li-Fi payment assistant unit of a service station, a light signal containing a payment message from a vehicle, transforming the payment message from a Li-Fi protocol format to a payment message format, where the Li-Fi protocol format is compatible with a Li-Fi protocol used by the service station for communication, decrypting the payment message to retrieve payment transaction information, executing the payment transaction information by communicating with one or more external networks via a payment gateway, and generating a payment acknowledgment based on a result of the execution. The disclosed embodiment provides a secure and streamlined method for handling payment transactions at a service station using Li-Fi communication. The disclosed method maintains compatibility between Li-Fi protocols and the service station's payment infrastructure and enables secure reception and decryption of sensitive payment data.

In one embodiment, the method may further include encrypting the payment acknowledgment, transforming the encrypted payment acknowledgment into the Li-Fi protocol format, encoding the payment acknowledgment into a light signal by modulating light emitted from one or more light sources of the service station and transmitting the light signal containing the payment acknowledgment to the vehicle. The disclosed embodiment strengthens the overall Li-Fi payment process by encrypting the payment acknowledgment and transmitting it to a vehicle via Li-Fi technology. Through this bidirectional communication, the driver in the vehicle may receive real-time payment confirmation, providing a secure and efficient transaction experience.

In one embodiment, the method may further include transmitting the payment acknowledgment to a user interface of the service station via a wired or wireless link. In one embodiment, the payment acknowledgment may comprise payment status information, and the payment status information may be presented via the user interface as a voice output, a text output, or a combination thereof. The disclosed embodiment enables the display of payment status to a driver in real-time at a user interface in the vehicle. This approach enhances the flexibility of the in-vehicle payment system and improves the overall user experience.

In one embodiment, the decryption of the payment message to retrieve the payment transaction information may be performed using a hardware-based encryption module and an encryption algorithm. The disclosed embodiment provides a secure approach for message decryption. The use of hardware-based encryption offers improved performance and reliability compared to software-only solutions and, therefore, enhances the overall security of the in-vehicle payment system.

In one embodiment, the method may further include integrating a foundation model into the Li-Fi payment assistant unit of the service station, generating a station-specific Li-Fi payment model by fine-tuning the foundation model to accommodate one or more station-specific requirements, refining the station-specific Li-Fi payment model using data related to the Li-Fi protocol, and applying the refined station-specific Li-Fi payment model to transform the payment message from the Li-Fi protocol format to a payment message format. The disclosed embodiment introduces the use of generative AI for message format transformation and encryption/decryption. The AI-driven approach simplifies the format message transformation process and improves the system's capability to handle diverse communication standards without manual intervention.

Additionally, or alternatively, in one embodiment, the method further comprises transmitting the payment acknowledgment to a user interface of the service station via a wired or wireless link, where the payment acknowledgment comprises payment status information, and the payment status information is presented via the user interface as a voice output, a text output, or a combination thereof. The disclosed embodiment has the technical effects of enhancing the system's accessibility and ensuring both drivers and station staff are promptly informed of the transaction status. A text display allows the station staff to quickly proceed with the requested service, while a voice output can provide accessibility for users who may not be able to view the screen. This embodiment may be applied to an example scenario where quick confirmation from the driver or station staff is needed to maintain operational efficiency at the service station.

Other embodiments in this disclosure provide systems comprising one or more processors and one or more memories storing a program, which, when executed on any combination of the one or more processors, perform operations in accordance with one or more of the above methods.

The existing approaches for in-vehicle payments for offline services, such as fuel or EV charging, often require expensive and complex modifications to the vehicle's structure and systems. The modifications introduced in existing solutions typically include the use of communication technologies such as NFC, RFID, and Bluetooth, which, however, present several limitations. First, technologies like NFC, RFID, and Bluetooth are constrained by short communication distance, requiring the vehicle to move close enough to the reader at the service station to complete the payment transaction. Additionally, these technologies pose security risks, as the transmitted data may be intercepted for unauthorized use or to gather sensitive data. Payment data may even be modified during transmission, potentially causing financial loss for the driver. Furthermore, transponders like NFC tags, RFID circuitry, and Bluetooth modules, due to their short-range nature, often need to be installed outside the vehicle to ensure proper communication, making these devices more vulnerable to physical damage or theft.

Some existing solutions also utilize Wi-Fi or cellular networks for payment communication. However, these networks may suffer from signal instability, particularly in remote or isolated areas, making payment transactions from vehicles unreliable. Furthermore, these methods have similar security challenges, as wireless data transmissions may be intercepted or compromised, leaving sensitive payment information at risk.

Due to the significant growth potential in the global transaction volume of in-vehicle payments, there is a pressing need for a robust, user-friendly, and secure in-vehicle payment solution specifically designed for offline services.

The present disclosure introduces methods, systems, and apparatus for using Li-Fi communication to facilitate secure and efficient payment transactions. The disclosed method addresses these challenges while enhancing the safety, convenience, and reliability of in-vehicle payments. In one embodiment of the present disclosure, a Li-Fi payment assistant unit is installed inside a vehicle and is connected to the vehicle's existing LED lights (e.g., LED headlights, LED daytime running lights (DRLs), or LED fog lights). The unit includes both hardware and software components that work together to facilitate the payment process. The hardware includes components for transmitting, receiving, and modulating light signals, while the software handles payment authentication, data encryption, message format transformation, and light modulation control. The combination of the vehicle's existing lights, along with these hardware and software components, constitutes a Li-Fi payment assistant within the vehicle.

When operated, the Li-Fi payment assistant system (also referred to briefly in some embodiments as Li-Fi payment assistant) first authenticates the payment by securely verifying the user's credentials. Once authentication is complete, the system modulates the light emitted from the existing LED lights to transmit payment information to the service station. Upon receiving the light-based transmission, the service station processes the payment and sends back an acknowledgment using Li-Fi communication. This acknowledgment confirms either a successful transaction or indicates a failure. Based on the acknowledgment, the system within the vehicle displays the transaction status to the driver on the main display or any other in-vehicle user interfaces (e.g., touchscreen, head-up display, or audio system).

This disclosed Li-Fi payment assistant system (also referred to briefly in some embodiments as Li-Fi payment assistant) within the vehicle offers several significant advantages. First, the system streamlines the payment processing and enables faster and more efficient communication between the vehicle and the service station using Li-Fi technology and generative AI-based digital assistant framework. This framework uses a foundation model trained on protocol-related data to facilitate rapid and accurate format transformation. Second, by utilizing the vehicle's existing LED lights for data transmission, the system avoids the need for substantial structural, mechanical, and electrical modifications to the vehicle and eliminates associated costs and risks. Also, the use of existing hardware reduces complexity and speeds up implementation process.

Third, the system provides enhanced security by restricting the communication range to the area directly between the vehicle's lights and the Li-Fi transceiver at the service station. This limited range makes it difficult for the visible signal to be intercepted by unauthorized parties, significantly improving the security of the payment transaction. Lastly, the system eliminates the dependency on internet connectivity, which is often required in conventional wireless payment systems. By using Li-Fi communication, the vehicle no longer relies on its own mobile data or internet connectivity to complete transactions. This eliminates common issues associated with network connectivity, such as low bandwidth, inconsistent speeds, or limited coverage, particularly in remote or congested areas.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

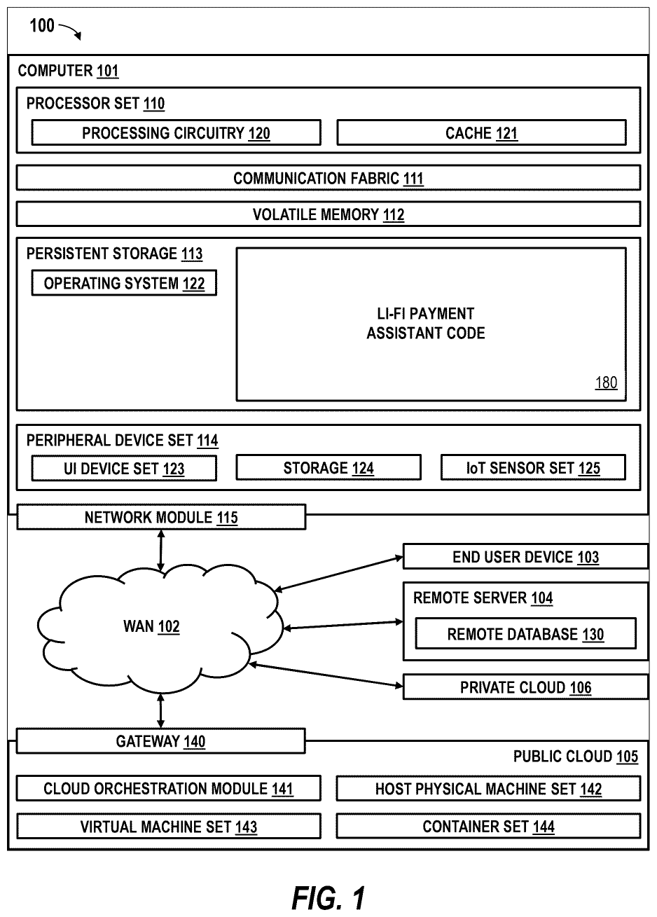

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Li-Fi Payment Assistant Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public clouds 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

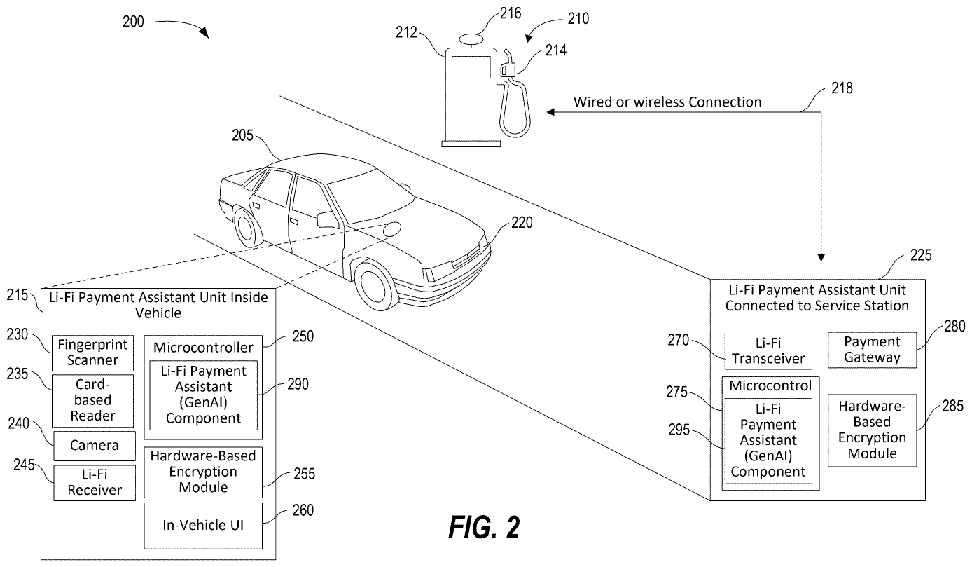

FIG. 2 depicts an example environment 200 for in-vehicle payments for offline services using Li-Fi communication and generative artificial intelligence, according to some embodiments of the present disclosure.

In the example environment 200, a vehicle 205 approaches a service station 210 for gas refueling. The service station for gas refueling 210 is only an example provided for conceptual clarity. In some embodiments, the service station 210 may be designed to provide a range of offline services, including, but not limited to, electrical vehicle (EV) charging, plug-in hybrid electrical vehicle (PHEV) charging, battery swap for EV/PHEV, fuel supply (petrol, diesel, hydrogen, or natural gas) for internal combustion engine (ICE) and hybrid vehicles, car wash, auto detailing, accessories, spare parts, routine maintenance, breakdown assistance, roadside support, and drive-through grocery or restaurant shopping.

In Li-Fi communication, visible light serves as the communication channel for transmitting data. The process works by modulating the light's intensity or frequency to encode data and transmitting the light signal over short distance. On the receiving end, a Li-Fi receiver (or Li-Fi transceiver, which is a combination of Li-Fi transmitter and receiver) decodes the modulated light signals back into usable data.

As depicted, a Li-Fi payment assistant unit 215 is positioned (or installed) inside the vehicle 205 and is connected to the existing LED lights 220, such as the LED headlights, LED DRLs, and LED fog lights. The Li-Fi payment assistant unit 215 is configured to modulate the visible light emitted from these built-in LED light sources 220 for data transmission. Unlike NFC tags or RFID circuitry, which typically need to be installed near the surface or outside of the vehicle to facilitate short-range wireless communication, the Li-Fi payment assistant unit 215, as shown, is installed inside the vehicle. This is because the vehicle's LED lights 220 are already positioned externally without obstruction, allowing them to act as efficient data transmitters. The Li-Fi payment assistant unit 215, placed within the vehicle 205, controls the modulation and transmission of data through the LEDs 220 without the need of being exposed to the external environment.

The use of existing LED lights 220, such as headlights, DRLs, or fog lights, serves as an example of the present disclosure, illustrating how Li-Fi communication may be integrated into a vehicle. In some embodiments, a dedicated Li-Fi LED light may be added to the vehicle specifically for data transmission. The dedicated LED light may be positioned externally or directed through a window, allowing the light signals can be received outside the vehicle. In some embodiments, the Li-Fi light may be temporarily affixed to the windshield or side window using an attachment (e.g., a suction cup or adhesive mount). This allows for more flexible positioning to facilitate clear, unobstructed communication with external receivers.

In some embodiments, installing the Li-Fi payment assistant unit 215 inside the vehicle 205 may bring several benefits. For example, it may avoid potential physical damage and theft, as the unit 215 is protected within the vehicle's interior. In some embodiments, the interior location may include areas such as the passenger compartment or non-passenger spaces like the engine compartment. The internal positioning may also shield the unit 215 from environmental factors such as weather, debris, and other external conditions that degrade externally mounted components and, therefore, extend the lifespan of the unit 215. Furthermore, installing the unit 215 internally may eliminate the need for significant (or in some cases, any) modifications to the vehicle's exterior, allowing for easier integration with the vehicle's existing systems while preserving the vehicle's original exterior design.

The Li-Fi payment assistant unit 215 inside the vehicle includes several hardware components that work together to facilitate secure and efficient in-vehicle payment processing. As depicted, the hardware components include a fingerprint scanner 230, a card-based reader 235, a camera 240, Li-Fi transceiver 245, a microcontroller 250, a hardware-based encryption module 255, and an in-vehicle user interface (UI) 260. In some embodiments, not all of these listed components are required. For example, either the fingerprint scanner 230 or camera 240 may be used to collect biometric information, or in some embodiments, neither may be necessary, with only the card-based reader 235 being utilized.

The fingerprint scanner 230 and camera 240 serve as biometric authentication tools to verify the payer's identity before processing payments. For example, the fingerprint scanner 230 is used to collect the fingerprint for payment authentication, and the camera is used to collect the facial information. The camera may further include a built-in processor that analyzes the collected facial data to perform facial recognition.

The card-based reader 235 is used to collect payment information from NFC-enabled cards or mobile devices that store digital wallets. The Li-Fi transceiver 245 is configured to modulate light for data transmission and receive light signals from external systems. More specifically, the Li-Fi transceiver 245 adjusts the intensity and/or frequency of light (from the existing in-vehicle light sources 220) to encode payment transaction data and then transmit the modulated light signals to an external system (e.g., Li-Fi payment assistant unit 225 connected to service station). In some embodiments, the Li-Fi transceiver 245 also works in reverse by receiving light signals transmitted from the external system and decode the light signals to retrieve payment acknowledgment information. In some embodiments, the Li-Fi transceiver may be a combination of a Li-Fi driver (or transmitter), which modulates light to transmit data, and a photodetector (or receiver), which captures incoming light signals for decoding.

The hardware-based encryption module 255 is a secure component within the unit designed to protect sensitive data (e.g., payment information, payer's fingerprint and facial images). The module 255 may include a secure element, hardware security module (HSM), trusted platform module (TPM), and be used to encrypt or decrypt data at the hardware level.

The in-vehicle user interface (UI) 260 refers to the devices through which the driver interacts with the Li-Fi payment assistant unit and views information about the transaction. The in-vehicle UI 260 may include a touchscreen, a head-up display, an audio system, or any other interface for interacting with the driver.

The microcontroller 250 acts as the central processing unit, coordinating all operations to complete the in-vehicle payment via Li-Fi communication. In some embodiments, the microcontroller 250 may be a computing device that contains a CPU, memory, storage, one or more network interfaces, and one or more I/O interfaces. Within the memory, as depicted, the microcontroller includes a Li-Fi payment assistant component 290. In some embodiments, the component 290 may be a collection of software code or programming instructions designed to coordinate and facilitate various tasks involved in Li-Fi-based communication and in-vehicle payment processing. In some embodiments, the Li-Fi payment assistant component 290 may be divided into several subcomponents, including a user interface management component (which handles driver interactions and present real-time status updates), a payment authorization component (which verifies the payer's identity and authorizes the transmission of payment data to a service station for further processing), an encryption/decryption component (which secures the sensitive payment data), a message format transformation component (which identifies Li-Fi protocol and manage data format transformation), and a light modulation component (which controls encoding and decoding of light signals for communication).

The Li-Fi payment assistant unit 215, which includes both the hardware (e.g., the Li-Fi transceiver 245, camera 240, card-based reader 235, fingerprint scanner 230, microcontroller, hardware-based encryption module 255, and in-vehicle UI 260) and software components (e.g., the user interface management component, payment authorization component, encryption/decryption component, message format transformation component, and light modulation component), as well as the vehicle's existing LED lights 220 connected to the vehicle, all together, constitute a Li-Fi payment assistant of the vehicle. Through this system, the vehicle is enabled to transmit and receive payment data via modulated visible light and complete in-vehicle payment securely and efficiently.

As depicted, the service station for gas refueling 210 includes a display screen 212, a fuel pump nozzle 214, and a vehicle detection sensor 216. The display screen 212 is used to present transaction information to the driver and the service station operator. In some embodiments, the display screen may show the payment status, fuel levels, and any other relevant service options or notification related to the vehicle's refueling process. The fuel pump nozzle 214 is the primary tool for dispensing fuel to the vehicle. Once the payment has been confirmed through the Li-Fi system, the fuel nozzle is enabled, allowing the driver to refuel the vehicle (e.g., petrol, diesel, or other fuel types) as part of the offline services provided by the station. The vehicle detection sensor 216 is configured to identify when a vehicle 205 approaches the service station 210. The sensor may include various types, such as an infrared (IR) sensor (which identifies a vehicle based on its heat signature), an ultrasonic sensor (which relies on sound waves to detect the presence and distance of a vehicle), a radar sensor (which uses radio waves for precise detection), or a camera using motion detection technology. Upon detecting the vehicle 205 approaching the station 210 (e.g., within a defined range of distance), the vehicle detection sensor 216 sends a signal to the Li-Fi payment assistant unit 225, prompting the unit 225 to activate and prepare to receive payment information transmitted from the vehicle 205. This setup allows the two Li-Fi payment assistant units 215 and 225 (one inside the vehicle and the other connected to the service station) to establish communication and process the payment securely and efficiently as the vehicle 205 approaches.

As depicted, Li-Fi transceiver component 270 of the Li-Fi payment assistant unit 225 is placed to align with the vehicle's light emitter. The receiver 270 may be physical located in any position corresponding to where the vehicle's lights are directed (e.g., positioned in front of where the vehicle will be facing if headlights are used as the light source). In some embodiments, the Li-Fi payment assistant unit 225 may be connected to the service station 210 via either wired cables (e.g., Ethernet cables) or wireless links 218 (e.g., Wi-Fi, Bluetooth, cellular network).

The Li-Fi payment assistant unit 225 is configured to handle the secure processing of payment transactions between the vehicle 205 and the service station 210. More specifically, Li-Fi transceiver component 270 of the unit 225 receives modulated light signals transmitted from the vehicle 205, decodes the payment information, and processes the data through the station's payment gateway 280. Once the transaction is complete, the unit 225 transmits acknowledgement signals back to the vehicle to confirm or reject the payment.

As depicted, the Li-Fi payment assistant unit 225 connected to the service station includes the following hardware components: a Li-Fi transceiver 270, a microcontroller 275, a payment gateway 280, and a hardware-based encryption module 285. The Li-Fi transceiver 270 handles both the transmission and reception of modulated light signals. The Li-Fi transceiver 270 receives light signals emitted from the vehicle's LED lights 220 and decodes the transmitted payment information. Once the transaction is complete, the Li-Fi transceiver 270 modulates light signals to encode and send the acknowledgement message back to the vehicle 205. In some embodiments, the Li-Fi transceiver 270 may be a combination of a Li-Fi driver (or transmitter), which modulates light signals to transmit data, and a photodetector (or receiver), which captures incoming light signals for decoding.

The payment gateway 280 is configured to connect the unit 225 to external networks (e.g., banks, payment processing intermediary, payment orchestrator or credit card processors), where the transaction is executed and processed. The hardware-based encryption module 285 (e.g., a secure element, HSM, TPM) manages the encryption and/or decryption of payment data and acknowledgement. The microcontroller 275 is the central processing unit and configured to coordinate the entire payment transaction within the unit 225, such as managing the reception and transmission of light signals, encryption and decryption of data, and communication with the station's payment gateway. In some embodiments, the microcontroller 275 may be a computing device that contains a CPU, memory, storage, one or more network interfaces, and one or more I/O interfaces. Within the memory, as depicted, the microcontroller 275 includes a Li-Fi payment assistant component 295. In some embodiments, the component 295 may be a collection of software code or programming instructions designed to complete Li-Fi in-vehicle payments. In some embodiments, the Li-Fi payment assistant component 295 may consist of several subcomponents, including a payment processing component (which communicates with the payment gateway to complete the payment transaction), a message format transformation component (which identifies the Li-Fi protocol(s) in use and manages data format transformation), an encryption/decryption component (which secures sensitive payment data by encrypting outgoing information and/or decrypting received data), and a light modulation component (which controls the encoding and/or decoding of light signals for Li-Fi communication).

In some embodiments, after the payment transaction is complete, the Li-Fi payment assistant unit 225, in addition to or instead of sending the acknowledgment to the vehicle (e.g., via modulated light signals), may send the acknowledgment directly to the service station 210 via the wired or wireless connection 218. The acknowledgment may include the payment status information, such as “payment completed” or “payment failed.” Once receiving the data, the service station 210 may display the data on its screen 212 to provide real-time feedback to the driver and/or station operator. This approach allows that both the vehicle driver and the station operator to be promptly informed of the transaction outcome.

The Li-Fi payment assistant unit 225, which includes both hardware (e.g., the Li-Fi transceiver 270, microcontroller 275, payment gateway 280, and hardware-based encryption module 285) and software components (e.g., the payment processing component, message format transformation component, encryption/decryption component, and light modulation component) together with the service station's infrastructures (e.g., the display screen 212, fuel pump 214, and vehicle detection sensor 216), all constitute a Li-Fi payment assistant of the service station. Through the system, the service station 210 is enabled to securely communicate with the vehicle, process payment transactions, and display real-time payment status.

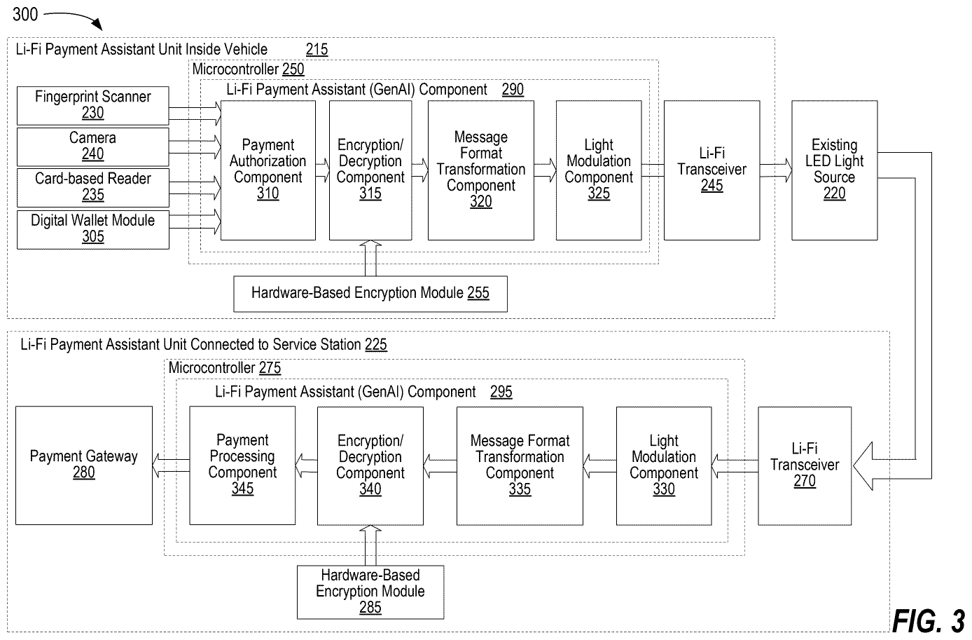

FIG. 3 depicts an example workflow 300 for authorizing and transmitting payment information from a vehicle to a service station via Li-Fi, according to some embodiments of the present disclosure.

In the example workflow 300, the fingerprint scanner 230 and/or camera 240 are configured to collect the driver's biometric information (e.g., fingerprint or facial data), which is used for identity verification. The card-based reader 235 collects the driver's card details for payment authorization. In some embodiments, in addition to or instead of handling physical card payments, the Li-Fi payment assistant unit 215 may further include a digital wallet module 305, which provide digital payment information for in-vehicle transactions. Both the biometric data (e.g., fingerprint or facial data) and the payment details (from either a physical card or a digital wallet) are provided to the payment authorization component 310. The payment authorization component 310 verifies the driver's identity using the biometric data and perform an initial check of the payment details, such as confirming whether the card number is in the correct format or identifying any missing information. Once complete, the payment authorization component 310 authorizes the transmission of the payment transaction data to the service station for further processing. In some embodiments, the payment transaction data may include card information, digital wallet information, payer's identity information, and other relevant data. The payment transaction data is then provided to the encryption/decryption component 315.

As depicted, the encryption/decryption component 315 works with the hardware-based encryption module (e.g., HSM) to encrypt the payment transaction data. In some embodiments, the encryption/decryption software component 315 handles the encryption logic, such as determining how the data should be encrypted and selecting the appropriate encryption algorithm (e.g., Advanced Encryption Standard (AEX) or Rivest-Shamir-Adleman (RSA)), and the hardware-based encryption module performs the actual encryption at the hardware level. This hardware-based encryption provides a higher level of security than software-based encryption because it isolates the encryption/decryption operations within specialized hardware (e.g., HSM), protecting these operations from potential vulnerabilities such as malware or tampering.

The encrypted data is passed to the message format transformation component 320. The message format transformation component 320 identifies the Li-Fi protocol(s) being used by the service station, and message format transformation component transforms the encrypted payment data (originating from payment authorization component 310 in a payment message format) (e.g., digital wallet data format, proprietary bank format) into a Li-Fi protocol-specific format, aligning with one of the identified protocols. In some embodiments, generative AI technology may be used for protocol identification and data transformation. More specifically, a foundation model pretrained on large-scale datasets (e.g., various Li-Fi protocols used by financial services) may be loaded (or integrated) into the message format transformation component 320. For application in a vehicle's Li-Fi payment assistant, the foundation model may be fine-tuned using system-specific data, allowing the model to adapt to the configurations or requirements of the vehicle and the environments it encounters (e.g., the service station). Once fine-tuned, the generative AI model may be applied to identify the Li-Fi protocol(s) used by the service station. Upon protocol identification, data related to the identified protocol(s) may be used to further refine the foundation model's capabilities. The refined generative AI model may then be applied for format transformation, adjusting the payment transaction data from a payment message format (which aligns with the vehicle's internal payment processing system) to the Li-Fi protocol-specific format required by the service station.

As illustrated, the encrypted and protocol-transformed payment data is provided to the light modulation component 325, which works with the Li-Fi transceiver 245 to modulate the light signals emitted from the vehicle's existing LED light sources 220 (e.g., headlights, DRLs, or fog lights) for data transmission. The light modulation component 325 encodes the payment data into a format suitable for transmission via visible light (e.g., binary data). The Li-Fi transceiver 245 then modulates the intensity or frequency of the LED lights based on the encoded data, converting digital data into modulated light signals for communication.

As depicted, the Li-Fi transceiver 270 captures the light signals from the vehicle. The captured light signals are first passed through the light modulation component 330 to decode the signals into digital data. The decoded data is still encrypted in a Li-Fi protocol-specific format. The message format transformation component 335 then process the decoded data and transforms it from the Li-Fi protocol-specific format into a payment message format (which is compatible with the service station's internal payment processing system). In some embodiments, message format transformation component 335 may use generative AI to perform format transformation. More specifically, the message format transformation component 335 may first load a foundation model that has been pretrained on large datasets related to communication protocols. The model may be fine-tuned to better adapted to the requirements of the service station and understand the specific Li-Fi protocol being used. The refined model may then be applied to transform the payment data in the Li-Fi protocol-specific format into a payment message format compatible with the station's internal payment processing system.

Once the data transformation is complete, the payment transaction data is then sent to the encryption/decryption component 340, which works in conjunction with the hardware-based encryption module (e.g., HSM) for decryption at the hardware level. The decrypted payment transaction data is then processed by the payment processing component 345, which communicates with the payment gateway 280 to complete the transaction. In some embodiments, the payment gateway 280 may connect to one or more external networks (e.g., banks, payment processing intermediary, payment orchestrator or credit card processors). The payment gateway 280 may share the received payment data with these external entities, which perform payment processing includes validation checks, such as verifying the payment details and checking for sufficient funds. Based on the results of these checks, the external entities either approve or decline the payment and send the result back to the payment gateway 280.

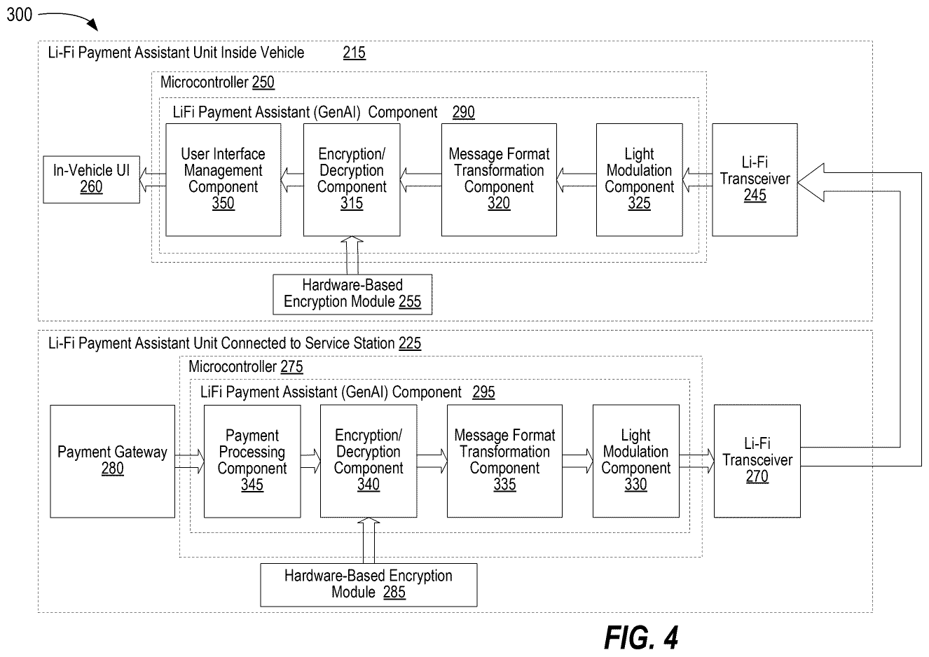

FIG. 4 depicts an example workflow 400 for processing and transmitting payment acknowledgment information from a service station to a vehicle via Li-Fi, according to some embodiments of the present disclosure.

As depicted, the payment gateway 280 receives the transaction result (failed or completed) from external networks. The payment gateway 280 then sends the result to the payment processing component 345, which prepares a payment acknowledgment (confirming the payment is complete or indicating the payment has failed). The acknowledgment is then processed by the encryption/decryption component 340.

As shown, the encryption/decryption component 340 works in conjunction with the hardware-based encryption module 285 to encrypt the acknowledgment message before sending it to the vehicle. After encryption, the encrypted acknowledgment is passed to the message format transformation component 335, which transforms the encrypted acknowledgment message into the appropriate Li-Fi protocol-specific format used by the service station for communication. In this configuration, protocol identification may be omitted since the service station operates within a predefined Li-Fi communication protocol. As the station is already configured to use a specific protocol, there is no need for additional protocol discovery. In some embodiments, generative AI technology may be used for data format transformation, such as fine-tuning a foundation model using samples of protocol-specific message format.

As depicted, the encrypted, protocol-specific message format-transformed acknowledgment message is processed by the light modulation component 330, which works in conjunction with the Li-Fi transceiver 270, to convent the digital data into light signals. The light modulation component 330 encodes the acknowledgement message into a format suitable for transmission via visible light (e.g., binary data). The Li-Fi transceiver 270 then modulates the intensity or frequency of the light to carry the encoded data. For example, by rapidly varying the on/off states of the LED, the light may be modulated to represent the data encoded as binary.

As illustrated, the light signals carrying the encrypted acknowledgment message is captured by the Li-Fi transceiver 245 inside the vehicle. The light modulation component 325 decodes the modulated light signals, and extracts the encrypted acknowledgment data. The message format transformation component 320 then transforms the acknowledgment message from the Li-Fi protocol-specific format back to the payment message format that the vehicle's system can process. In some embodiments, generative AI may be used, where a fine-tuned model is applied to perform the format transformation.

After decryption, the acknowledgment data is processed by the encryption/decryption component 315, which works with the hardware-based encryption module 255 (e.g., HSM) to decrypt the data at the hardware level. The decrypted acknowledgment message is then transmitted to the user interface management component 350. As discussed above, the acknowledgment message includes data that reflects the transaction result or payment status, either confirming the successful completion of the transaction or indicating a failure. The user interface management component 350, upon receiving the acknowledgment, instructs the in-vehicle UI 260 (e.g., touchscreen, head-up display, audio system) to communicate the result to the driver. In some embodiments, the transaction result may be displayed in the form of text on a touchscreen or head-up display within the vehicle. In some embodiments, the transaction results may be communicated through voice outputs, played via the vehicle's audio system.

As depicted in FIGS. 3 and 4, the payment authorization component 310, encryption/decryption component 315, message format transformation component 320, light modulation component 325, user interface management component 350 are software modules or programming instructions embedded within the microcontroller 250. These components collectively function as part of the broader Li-Fi payment assistant (GenAI) component 290. These software components work with the hardware components of the Li-Fi payment assistant unit 215 to securely manage the transmission of payment data and the reception of payment acknowledgment. Similarly, as depicted in FIGS. 3 and 4, the payment processing component 345, encryption/decryption component 340, message format transformation component 335, light modulation component 330 are software modules or programming instructions within the microcontroller 275. These components collectively function as part of the broader Li-Fi payment assistant (GenAI) component 295. These software components, in coordination with the hardware components of the Li-Fi payment assistant unit 225, enable the secure reception of payment data from the vehicle and the transmission of acknowledgment signals back to the vehicle.

FIGS. 3 and 4 illustrate how a hardware-based encryption module 255 or 285 (e.g., secure element, HSM, TPM) works in conjunction with the encryption/decryption software component 315 or 340 to perform the encryption and/or decryption operations. This setup provides a high level of security, as the encryption/decryption processes are isolated in hardware, making the data less vulnerable to tampering or unauthorized access. The hardware-based encryption/decryption system is provided for conceptual clarity. In some embodiments, software-based encryption/decryption may be implemented for secure data handling. The software-based encryption/decryption system may perform data encryption/decryption at either the network level, the message level, or a combination of both.

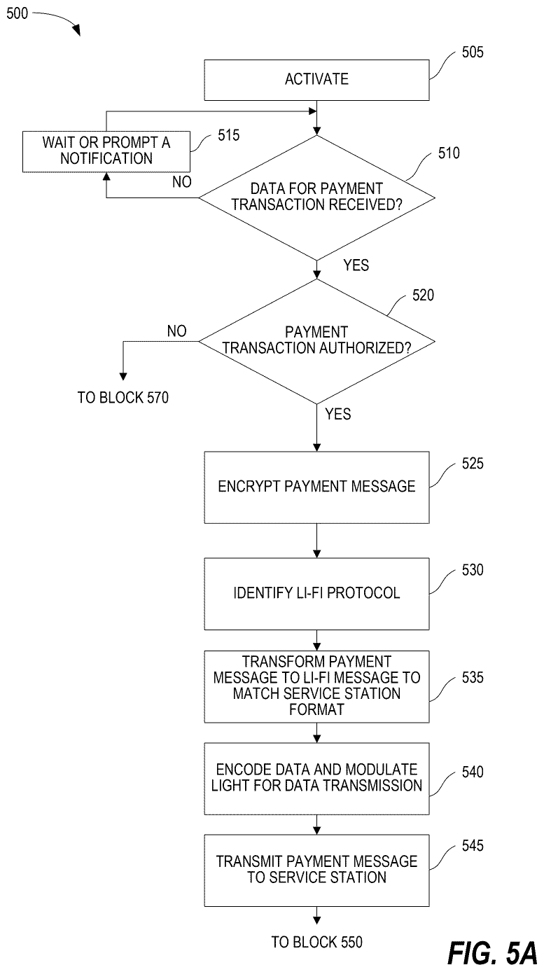

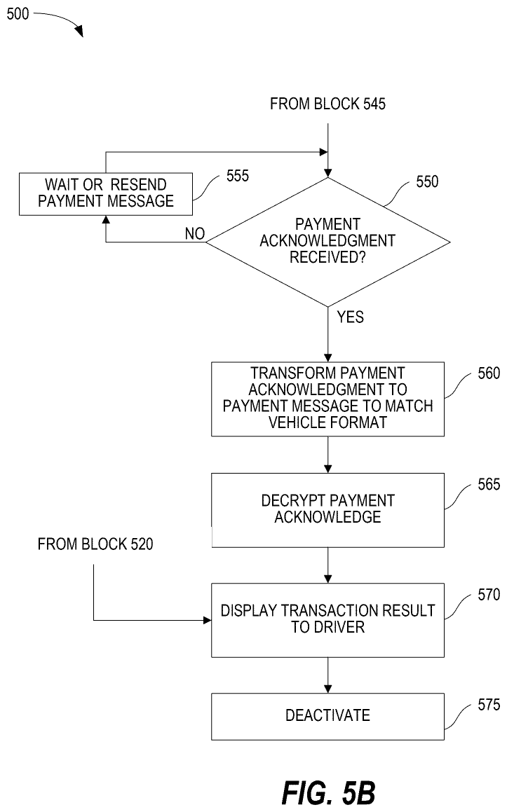

FIGS. 5A and 5B depict an example method 500 for a vehicle authorizing and transmitting payment transaction information to a service station using Li-Fi payment assistant, according to some embodiments of the present disclosure. In some embodiments, the example method 500 may be performed by any computing device that is capable of executing the necessary software and interacting with hardware components to handle Li-Fi communication, encryption, and payment processing. In some embodiments, the example method may be performed by the Li-Fi payment assistant unit 215 as depicted in FIG. 2, which is installed inside a vehicle and integrated with the vehicle's existing LED lights. The Li-Fi payment assistant unit 215 is part of the overall Li-Fi payment assistant system of the vehicle and utilizes the existing LED lights for data transmission.

At block 505, a vehicle's Li-Fi payment assistant system is activated as the vehicle (e.g., 205 of FIG. 2) approaches a service station (e.g., 210 of FIG. 2) for offline services. As used herein, offline services refer to those where internet connectivity may not be required for payment, such as parking payments, refueling at gas stations or recharging at EV charging points, toll payments, and car wash services. In contrast, online services typically involve ongoing activity to the internet for subscription-based offerings, such as entertainment services or the activation of paid vehicle features (e.g., enhanced navigation or advanced driver assistance system). As used herein, activating the vehicle's Li-Fi payment assistant system (or unit) may include initializing the Li-Fi payment assistant unit (e.g., 215 of FIG. 2) installed inside the vehicle, which prepares the relevant hardware and software components for payment processing and Li-Fi communication. In some embodiments, the Li-Fi payment assistant system may be activated manually by the driver manually clicking a button on the in-vehicle screen or using voice commands, instructing the unit (e.g., 215 of FIG. 2) to initiate the payment process. In some embodiments, the system may be automatically activated based on sensor detection, such as the vehicle's proximity to the service station (e.g., within a defined range of distance from the service station) or the presence of a specific Li-Fi signal. In some embodiments, upon detecting the vehicle's approach to a service station, a notification may be automatically prompted and displayed on the in-vehicle user interface (UI), allowing the driver (or user) to select whether to activate the in-vehicle Li-Fi payment assistant.

At block 510, the Li-Fi payment assistant system of the vehicle checks (e.g., via the payment authorization component 310 of FIG. 3) whether the necessary data for payment transaction and authorization has been received. In some embodiments, the data may include payment details (e.g., card information) and biometric data of the payer (e.g., fingerprint or facial recognition). In some embodiments, the payment details may be collected from a physical card via a card-based reader (e.g., 235 of FIG. 3) or from a digital wallet stored on a mobile device or within the vehicle (e.g., 305 of FIG. 3). In some embodiments, the biometric data may be collected through the vehicle's built-in camera for facial recognition (e.g., 240 of FIG. 3) or a fingerprint scanner for fingerprint authentication (e.g., 230 of FIG. 3). The payment information and the biometric data are required for initiating the payment transaction and verifying the identity of the payer for authorization.

If no data or not all the required data has been received, the method 500 moves to block 515, where the Li-Fi payment assistant system waits for the necessary information to be collected. In some embodiments, a specific period of time may be defined, and if the system still does not receive the date.

After that period, the system may prompt a notification to the driver via the in-vehicle UI (e.g., touchscreen or audio system), requesting the driver to provide the missing information. If all the required data has been received, the method 500 proceeds to block 520.

At block 520, the Li-Fi assistant system verifies (e.g., via the payment authorization component 310 of FIG. 3) whether the biometric data and payment details are valid. More specifically, the system checks whether the payment information is valid (e.g., whether the card number is in the correct format or if any information is missing), and the biometric data matches the authorized payer. If the data is valid, the method proceeds to block 525, where the system authorizes the transmission of the data to the service station for further processing. If not valid, the method proceeds to block 570 (in FIG. 5B), where the system displays a failure notification to the driver via the in-vehicle UI. The notification informs the driver of the issue (e.g., incorrect card information, mismatch biometric data) and requests the driver to retry and provide correct information.

At block 525, the vehicle's Li-Fi payment assistant system (e.g., via the encryption/decryption component 315 as depicted in FIG. 3) encrypts the payment transaction data to protect sensitive information before transmitting it to the service station. The system may work in conjunction with a hardware-based encryption module (e.g., HSM or secure element) (e.g., 255 of FIG. 3) to perform the encryption at the hardware level.

At block 530, after encryption, the Li-Fi payment assistant system (e.g., via the message format transformation component 320 as depicted in FIG. 3) identifies the specific Li-Fi communication protocol(s) in use by the service station. Various Li-Fi communication protocols are defined by industry standards, and each service station may only support a subset of these protocols. With the identified protocol(s), the vehicle may transform the payment transaction data into a format recognized (or supported) by the service station.

At block 535, the Li-Fi payment assistant system (e.g., via the message format transformation component 320 as depicted in FIG. 3) transforms the payment message to align with the identified Li-Fi protocol(s). The payment message may initially be in a format compatible with the vehicle's internal payment processing system (referred to in some embodiments as the payment message format required by the vehicle). To facilitate communication with the service station, at block 535, the message is transformed from the payment message format to a format aligned with one of the identified Li-Fi protocol(s) (also referred to in some embodiments as the Li-Fi protocol-specific format). This transformation allows the payment transaction data to be transmitted effectively using the Li-Fi communication channel.

In some embodiments, generative AI may be implemented for protocol identification and format transformation. The process may begin by integrating a foundation model into the system. The foundation model, pretrained on large datasets (e.g., various Li-Fi protocols used by financial services), may be fine-tuned to create a vehicle-specific model that accommodates the specific configurations or requirements of the vehicle (e.g., communication range, hardware limitations, encryption standards). Once fine-tuned, the vehicle-specific model may be applied to identify the specific Li-Fi protocol(s) used by the service station. After identifying the protocol(s), data related to the identified protocol(s) may be used to further refine the model's capabilities, making the model to adapt more precisely to the communication standards in use. The refined model may then be applied to transform the encrypted payment message (e.g., containing payment transaction data) from the payment message format into the format compatible with the identified Li-Fi protocol(s).

At block 540, the vehicle's Li-Fi payment assistant system encodes (e.g., via the light modulation component 325 of FIG. 3) the payment transaction data into a format suitable for transmission via visible light (e.g., binary data). The system then modulates the light (e.g., from the vehicle's LED lights 220 of FIG. 3) through the Li-Fi transceiver (e.g., 245 of FIG. 2) to transmit the encoded data to the service station. The data encoding and light modulation allow the payment message to be sent wirelessly via Li-Fi communication.

At block 545, the modulated light signal carrying the payment transaction data is sent to the service station. In some embodiments, upon receiving the signal, the service station's Li-Fi payment assistant system may decode the light signal, transform the received data format, and decrypt the payment transaction data. The service station may then forward the data to a payment gateway (e.g., 280 of FIG. 3), which executes and processes the payment details by communicating with the relevant financial institutions or card networks to ensure that the payment authorization is approved and funds are available. Following the completion of the payment processing, the payment gateway may inform the service station of the transaction result (failed or completed), which in turn generates a payment acknowledgment and sends it back to the vehicle in response to the original request. If the payment is successful, the acknowledgment indicates the completion of the transaction. If the payment fails, possible due to insufficient funds, invalid payment details, or a failure to verify the payer's identity, the acknowledgment specifies the failure.

At block 550 (in FIG. 5B), the Li-Fi payment assistant system checks whether a payment acknowledgment has been received from the service station. As discussed above, the acknowledgment may indicate either the successful completion of the transaction or a failure, depending on the outcome of the payment processing. In some embodiments, the acknowledgment may be transmitted back the vehicle via modulated light signals, captured by the vehicle's Li-Fi transceiver (e.g., 245 of FIG. 4), and decoded by the light modulation component (e.g., 325 of FIG. 4). If the acknowledgment is received, the method 500 moves to block 560. If no acknowledgment is received, the method 500 moves to block 555, where the system waits for a defined period of time, and if the period passes, the system resends the payment message to the service station. In some embodiments, the system may perform a certain number of attempts and if all fail, the system may prompt a notification to the driver via the in-vehicle UI, informing the drive that the payment has failed.

At block 560, the Li-Fi payment assistant system transforms (e.g., via the message format transformation component 320 of FIG. 4) the received acknowledgment message from the Li-Fi protocol-specific format into the payment message format used by the vehicle's internal processing system. In some embodiments, a fine-tuned generative AI model may be used to perform the format transformation.

At block 565, the vehicle's Li-Fi payment assistant system (e.g., via the encryption/decryption component 315 as depicted in FIG. 3) decrypts the acknowledgment message to retrieve the relevant data, such as the transaction result (failed or completed) (also referred to in some embodiments as the payment status information). The system may work in conjunction with a hardware-based encryption module (e.g., HSM or secure element) to perform the decryption at the hardware level. In some embodiments, encryption and decryption operations may be performed entirely through software, using cryptographic algorithms at either the network level or the message level.

At block 570, the transaction result is communicated to the driver via in-vehicle UI (e.g., 260 of FIG. 4). This may include messages such as “payment completed” or “payment failed,” either virtually displayed in the form of text on the vehicle's dashboard screen or via voice output through the in-vehicle audio system.

At block 575, the Li-Fi payment assistant system of the vehicle is deactivated following the completion of the transaction. The deactivation may be manually triggered by the driver clicking a button on the in-vehicle UI or using voice commands to shut down the system. In some embodiments, the system may be automatically deactivated based on sensor detection, such as when the vehicle drives away from the service station (e.g., leaving the defined range of distance from the station).

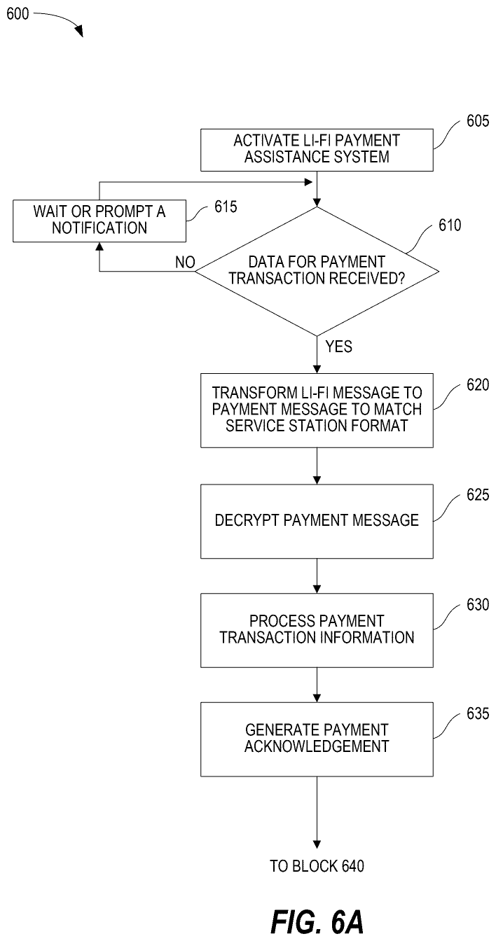

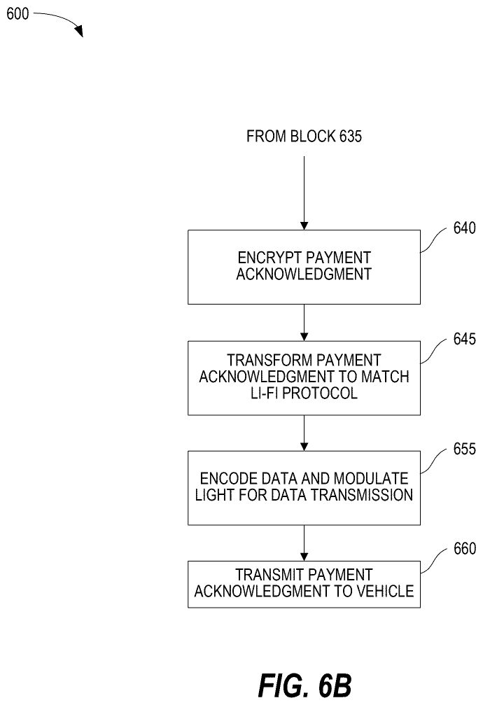

FIGS. 6A and 6B depict an example method 600 for a service station processing and transmitting payment acknowledgment information to a vehicle using Li-Fi payment assistant system, according to some embodiments of the present disclosure. In some embodiments, the example method 600 may be performed by any computing device that is capable of executing the necessary software and interacting with hardware components to handle Li-Fi communication, encryption, and payment processing and validation. In some embodiments, the example method may be performed by the Li-Fi payment assistant unit 225 as depicted in FIG. 2, Li-Fi transceiver of which is installed at the exit lane of the service station 210 and aligned with the vehicle's lights 220 for effective Li-Fi communication. The unit 225 is remotely connected to the service station 210 via wired or wireless links 218 to ensure data exchange between the unit and the service station. The Li-Fi payment assistant unit 225 and the service station constitute the station's overall Li-Fi payment assistant system, working in conjunction to facilitate secure and efficient payment transactions.

At block 605, the Li-Fi payment assistant system of a service station (e.g., 210 of FIG. 1) is activated. As used herein, activating the vehicle's Li-Fi payment assistant may include initializing the Li-Fi payment assistant unit (e.g., 225 of FIG. 2), which is connected to the service station and positioned at the exit lane and near the boom barrier. The initialization prepares the relevant hardware and software components to receive payment data from the vehicle and complete the transaction. In some embodiments, the Li-Fi payment assistant system may remain active continuously if the service station operates 24 hours a day. In some embodiments, the Li-Fi payment assistant may align with the station's schedule, such as being activated at the beginning of the service station's operating hours and deactivate at the end of the day. In some embodiments, such as when power-saving mode is implemented, the Li-Fi payment assistant system may be activated only upon detecting the approach of a vehicle moving at a low speed (e.g., falling within a defined threshold). In some embodiments, activation may be triggered by the vehicle sending a light signal to the unit or manually initiated by the driver passing the service station and pressing a button at the station.

At block 610, the station's Li-Fi payment assistant system checks whether the payment transaction data has been received. The data may include payment details (e.g., card information) and/or the payer's biometric data (e.g., fingerprint or facial recognition data). The transaction payment data may be sent from the vehicle via modulated light signals, which are captured by the service station's Li-Fi transceiver (e.g., 270 of FIG. 3) and decoded by its light modulation component (e.g., 330 of FIG. 3). If the data is received, the method 600 proceeds to block 620. If the data has not been received from the vehicle, the method 600 proceeds to block 615. At block 615, the system waits for a defined period of time. If the data is still not received after the defined period, the system may prompt a notification that is either displayed on the service station's display screen (e.g., 212 of FIG. 2) or transmitted as a message back to the vehicle via Li-Fi.

At block 620, the station's Li-Fi payment assistant system transforms (e.g., via the message format transformation component 335 of FIG. 3) the payment transaction data from the Li-Fi protocol-specific format into a format aligned with the service station's processing system (also referred to in some embodiments as the payment message format required by the service station). In some embodiments, a fine-tuned generative AI model may be used to perform the transformation. The model, based on a foundation model, may be refined using data related to the identified Li-Fi protocol(s) to ensure more accurately transformation between the Li-Fi protocol-specific format and the payment message format required by the service station.

At block 625, the Li-Fi payment assistant system decrypts the payment transaction data (e.g., using the encryption/decryption component 340 of FIG. 3) to access the necessary information for the transaction. In some embodiments, the system may use a hardware-based encryption module (e.g., HSM or secure element) (e.g., 285 of FIG. 3) to perform the decryption at the hardware level.

At block 630, the payment data sent by the vehicle is executed and processed by the station's Li-Fi system (e.g., via the payment processing component 345 of FIG. 3). In some embodiments, the Li-Fi system may forward the payment data to a payment gateway (e.g., 280 of FIG. 3), which communicates with financial institutions or card networks to verify the accuracy of the payment details and determine whether sufficient funds are available. If the payment is valid, the transaction is completed. If the payment details are incorrect or there are insufficient funds, the payment fails. The payment gateway may then forward the transaction result (or payment status information), received from the external networks, back to the Li-Fi system.

At block 635, the Li-Fi payment assistant system generates a payment acknowledgment message (e.g., via the payment processing component 345 of FIG. 4). The acknowledgment may indicate either a successful transaction or a failure.

At block 640 (in FIG. 6B), the Li-Fi payment assistant system encrypts the acknowledgment message to protect the sensitive information during the transmission back to the vehicle. The encryption may be performed using the encryption/decryption software component (e.g., 340 of FIG. 4) to handle encryption logic and select the appropriate encryption algorithms, and using the hardware-based encryption module (e.g., HSM) (e.g., 285 of FIG. 4) to perform the actual encryption at the hardware level. In some embodiments, the decryption and encryption operations may be performed entirely through software, using cryptographic algorithms at either the network level or the message level.

At block 645, the encrypted payment acknowledgment message is transformed from the payment message format into the Li-Fi protocol-specific format (which aligns with the identified Li-Fi protocol(s)). In some embodiments, a fine-tuned generative AI model may be implemented to perform the format transformation.

At block 650, the station's Li-Fi system encodes the transformed acknowledgment data (e.g., via the light modulation component 330 of FIG. 3) and modulates the light to send the acknowledgment data to the vehicle.

At block 655, the modulated light signals carrying the acknowledgment data are transmitted from the service stations' Li-Fi transceiver (e.g., 270 of FIG. 4) to the vehicle's Li-Fi transceiver (e.g., 245 of FIG. 4).

In some embodiments, the system may be automatically deactivated after the payment transaction is successfully completed and the acknowledgment has been transmitted. In some embodiments, the system may be deactivated upon the service station's vehicle detection sensor detecting that the vehicle is leaving the station, indicating the end of the interaction.

In some embodiments, the operations from blocks 640 to 660 may be skipped, where the payment acknowledgment message is not sent back to the vehicle via Li-Fi. Instead, the acknowledgment may be sent to the service station and displayed on the station's screen (e.g., 212 of FIG. 2) for confirmation. In embodiments where the Li-Fi payment assistant unit (e.g., 225 of FIG. 2) and the service station (e.g., 210 of FIG. 2) are remotely connected, the acknowledgment message may be sent from the unit (e.g., 225 of FIG. 2) to the station (e.g., 210 of FIG. 2) via the wired or wireless connection.

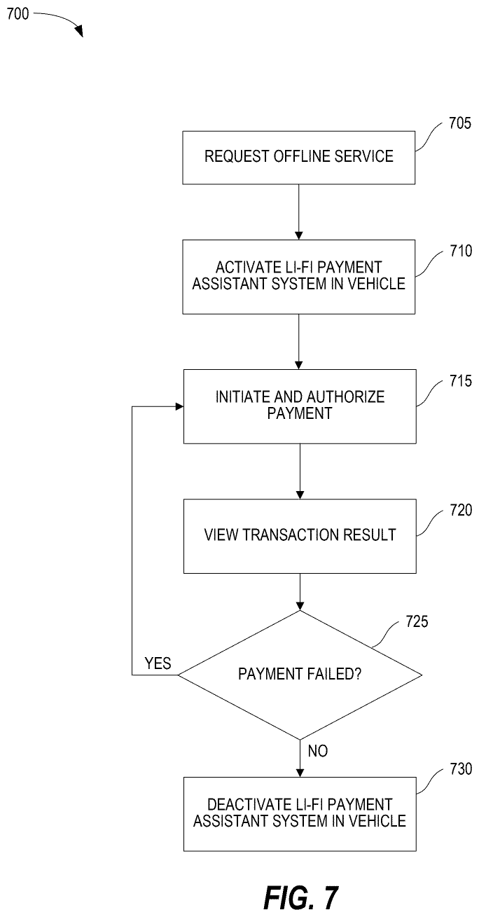

FIG. 7 depicts an example method 700 for driver interaction with the Li-Fi payment assistant, according to some embodiments of the present disclosure.

At 705, a driver requests offline service, which may involve parking the vehicle (e.g., 205 of FIG. 2) near a service station (e.g., 210 of FIG. 2).

At block 710, the driver activates the Li-Fi payment assistant system of the vehicle. In some embodiments, the vehicle's Li-Fi system may be activated manually by the driver clicking a button on the in-vehicle UI or automatically based on sensor detection when the vehicle approaches the station.

At block 715, the driver initiates and authorizes the payments. In some embodiments, the driver may enter payment details, either by tapping a card on a cared-based reader (e.g., 235 of FIG. 2) or using a stored digital wallet. After entering the payment details, the driver may then provide biometric data for identity verification. This may involve placing a finger near a fingerprint scanner (e.g., 230 of FIG. 2) or positioning herself in front of the vehicle's camera for facial recognition. The Li-Fi system collects and verifies the data to proceed with the transaction.

At block 720, the driver views the transaction result on the in-vehicle UI. The results may indicate whether the payment is successful or not. In some embodiments, the transaction results may also be transmitted directly to the service station and displayed on the station's screen (e.g., 212 of FIG. 2).

At block 725, the driver determines whether the payment has failed. If the payment has failed, the method 700 returns to block 715, where the driver reauthorizes the payment by reentering the payment details or resolving any issues. If the payment is successful, the method 700 moves to block 730.

At block 730, the driver deactivates the Li-Fi payment assistant system in the vehicle. In some embodiments, the deactivation may be performed manually by clicking a button on the in-vehicle UI or using voice commands. In some embodiments, the system may be deactivated automatically based on proximity sensors as the vehicle leaves the station.

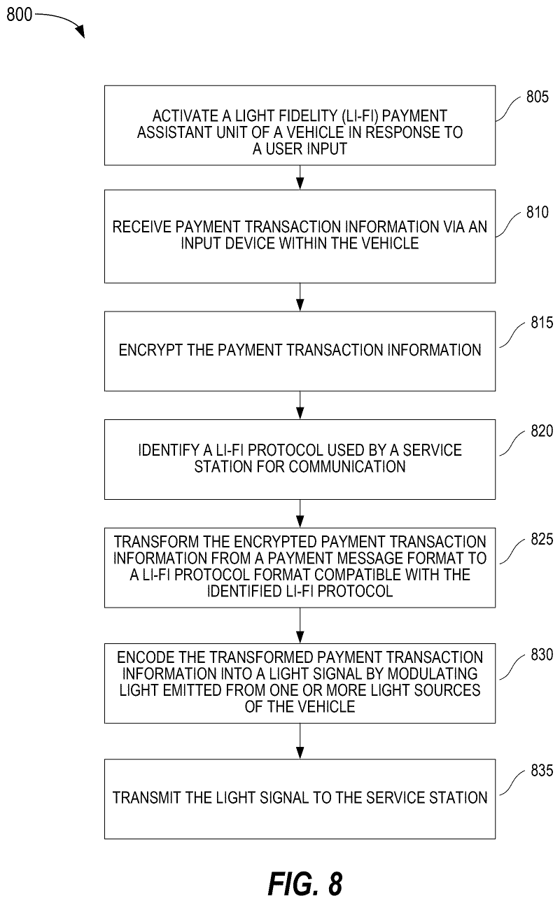

FIG. 8 is a flow diagram depicting an example method 800 for in-vehicle Li-Fi payment processing, according to some embodiments of the present disclosure.

At block 805, a Light Fidelity (Li-Fi) payment assistant unit of a vehicle is activated in response to a user input.

At block 810, the Li-Fi payment assistant unit receives payment transaction information via an input device within the vehicle. In some embodiments, the input device may be selected from the group consisting of a fingerprint scanner (e.g., 230 of FIG. 2), a camera with facial recognition functionality (e.g., 240 of FIG. 2), or a card-based reader (e.g., card-based reader 235 of FIG. 2).

At block 810, the Li-Fi payment assistant unit encrypts the payment transaction information. In some embodiments, the encryption of the payment transaction information may be performed using a hardware-based encryption module (e.g., 255 of FIG. 2) and an encryption algorithm (e.g., 315 of FIG. 3).

At block 815, the Li-Fi payment assistant unit identifies a Li-Fi protocol used by a service station for communication.

At block 820, the Li-Fi payment assistant unit transforms the encrypted payment transaction information from a payment message format to a Li-Fi protocol format compatible with the identified Li-Fi protocol.

At block 825, the Li-Fi payment assistant unit encodes the transformed payment transaction information into a light signal by modulating light emitted from one or more light sources of the vehicle.

At block 830, the Li-Fi payment assistant unit transmits the light signal to the service station.

In some embodiments, the Li-Fi payment assistant unit may further receive a light signal containing an encrypted payment acknowledgement from the service station, transform the encrypted payment acknowledgement from the Li-Fi protocol format into the payment message format, decrypt the encrypted payment acknowledgement to retrieve payment status information, display the payment status information via a user interface (e.g., 260 of FIG. 2) within the vehicle, and deactivate the Li-Fi payment assistant unit in response to a second user input or a completion of payment.

In some embodiments, the payment status information may be presented as a voice output, a text output, or a combination thereof.

In some embodiments, the one or more light sources of the vehicle (e.g., 220 of FIG. 2) may be selected from the group consisting of a headlight of the vehicle, a daytime running light (DRL) of the vehicle, or a fog light of the vehicle.

In some embodiments, the Li-Fi payment assistant unit may further integrate a foundation model into the Li-Fi payment assistant unit of the vehicle, generate a vehicle-specific Li-Fi payment model by fine-tuning the foundation model to accommodate one or more vehicle-specific requirements, apply the vehicle-specific Li-Fi payment model to identify the Li-Fi protocol used by the service station for communication, refine the vehicle-specific Li-Fi payment model using data related to the identified Li-Fi protocol, and apply the refined vehicle-specific Li-Fi payment model to transform the encrypted payment transaction information from a payment message format to the Li-Fi protocol format.

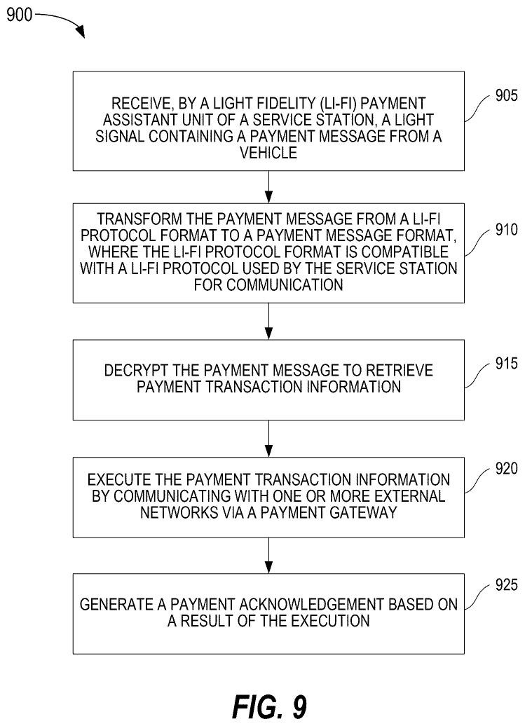

FIG. 9 is a flow diagram depicting an example method 900 for Li-Fi payment processing at a service station, according to some embodiments of the present disclosure.

At block 905, a Light Fidelity (Li-Fi) payment assistant unit of a service station receives a light signal containing a payment message from a vehicle (e.g., 205 of FIG. 2).

At block 910, the Li-Fi payment assistant unit transforms the payment message from a Li-Fi protocol format to a payment message format, where the Li-Fi protocol format is compatible with a Li-Fi protocol used by the service station for communication.

At block 915, the Li-Fi payment assistant unit decrypts the payment message to retrieve payment transaction information.

At block 920, the Li-Fi payment assistant unit executes the payment transaction information by communicating with one or more external networks via a payment gateway.

At block 925, the Li-Fi payment assistant unit generates a payment acknowledgment based on a result of the execution.

In some embodiments, the Li-Fi payment assistant unit may further encrypt the payment acknowledgment, transform the encrypted payment acknowledgment into the Li-Fi protocol format, encode the payment acknowledgment into a light signal by modulating light emitted from one or more light sources of the service station, and transmit the light signal containing the payment acknowledgment to the vehicle.

In some embodiments, the Li-Fi payment assistant unit may further transmit the payment acknowledgment to a user interface (e.g., 212 of FIG. 2) via a wired or wireless link (e.g., 218 of FIG. 2).

In some embodiments, the payment acknowledgment may comprise payment status information, and the payment status information may be presented via the user interface as a voice output, a text output, or a combination thereof.

In some embodiments, the decryption of the payment message to retrieve the payment transaction information may be performed using a hardware-based encryption module (e.g., 285 of FIG. 2) and a decryption algorithm (e.g., 340 of FIG. 3).

In some embodiments, the Li-Fi payment assistant unit may further integrate a foundation model into the Li-Fi payment assistant unit of the service station, generate a station-specific Li-Fi payment model by fine-tuning the foundation model to accommodate one or more station-specific requirements, refine the station-specific Li-Fi payment model using data related to the Li-Fi protocol, and apply the refined station-specific Li-Fi payment model to transform the payment message from the Li-Fi protocol format to a payment message format.

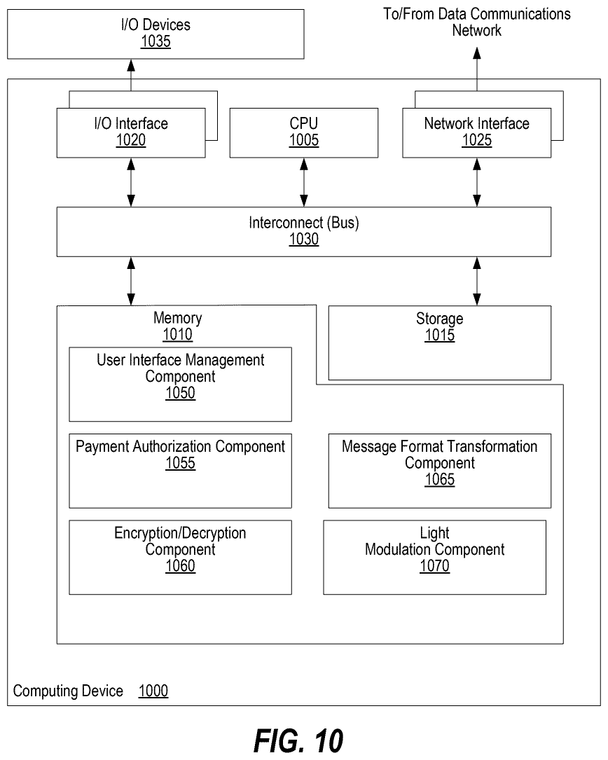

FIG. 10 depicts an example computing device 1000 configured to perform various aspects of the present disclosure, according to some embodiments of the present disclosure. In some embodiments, the computing device 1000 may correspond to the microcontroller 250 as depicted in FIG. 2, which is part of the Li-Fi payment assistant unit 215 installed inside a vehicle.

As illustrated, the computing device 1000 includes a CPU 1005, memory 1010, storage 1015, one or more network interfaces 1025, and one or more I/O interfaces 1020. In the illustrated embodiment, the CPU 1005 retrieves and executes programming instructions stored in memory 1010, as well as stores and retrieves application data residing in storage 1015. The CPU 1005 is generally representative of a single CPU and/or GPU, multiple CPUs and/or GPUs, a single CPU and/or GPU having multiple processing cores, and the like. The memory 1010 is generally considered to be representative of a random access memory. Storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1035 (such as keyboards, monitors, etc.) are connected via the I/O interface(s) 1020. Further, via the network interface 1025, the computing device 1000 can be communicatively coupled with one or more other devices and components (e.g., via a network, which may include the Internet, local network(s), and the like). As illustrated, the CPU 1005, memory 1010, storage 1015, network interface(s) 1025, and I/O interface(s) 1020 are communicatively coupled by one or more buses 1030.

In the illustrated embodiment, the memory 1010 includes a user interface management component authorization component 1055, an encryption/decryption component 1060, a message format transformation component 1065, and a light modulation component 1070. Although depicted as discrete components for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

The user interface management component 1050 manages the in-vehicle user interface (e.g., touchscreen, head-up display, audio system) to display payment status information (e.g., payment failed or completed) and prompts the drivers for inputs (e.g., providing payment details, payer's biometric data). The payment authorization component 1055 checks the validity of card information and biometric data before sending the data to a service station. The encryption/decryption component 1060 includes encryption/decryption algorithms and works with hardware-based modules (e.g., HSM) to encrypt data before transmission and/or decrypt received data from external systems. The message format transformation component 1065 manages the communication between the vehicle and the service station using Li-Fi technology. In some embodiments, the message format transformation component 1065 may use generative AI model to identify the Li-Fi protocol used by the service station. In some embodiments, the component 1065 may use the generative AI model to transform outgoing data to match the identified Li-Fi protocol, and transform received data into a format that is compatible with the vehicle's internal payment processing system. The light modulation component 1070 encodes the payment transaction data into light signals and decodes received light signals from the service station to retrieve payment acknowledgment.

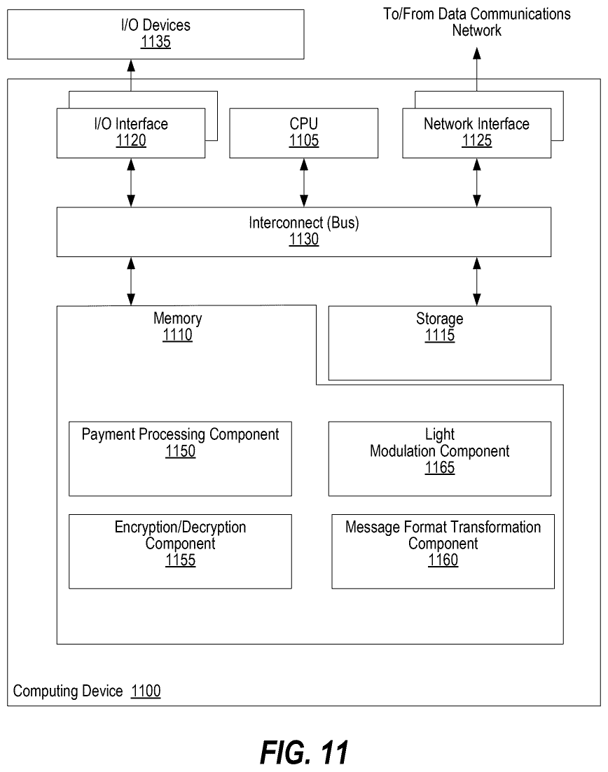

FIG. 11 depicts an example computing device 1100 configured to perform various aspects of the present disclosure, according to some embodiments of the present disclosure. In some embodiments, the computing device 1000 may correspond to the microcontroller 275 as depicted in FIG. 2, which is part of the Li-Fi payment assistant unit 225, which is connected to the service station 210.

As illustrated, the computing device 1100 includes a CPU 1105, memory 1110, storage 1115, one or more network interfaces 1125, and one or more I/O interfaces 1120. In the illustrated embodiment, the CPU 1105 retrieves and executes programming instructions stored in memory 1110, as well as stores and retrieves application data residing in storage 1115. The CPU 1105 is generally representative of a single CPU and/or GPU, multiple CPUs and/or GPUs, a single CPU and/or GPU having multiple processing cores, and the like. The memory 1110 is generally considered to be representative of a random access memory. Storage 1115 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1135 (such as keyboards, monitors, etc.) are connected via the I/O interface(s) 1120. Further, via the network interface 1125, the computing device 1100 can be communicatively coupled with one or more other devices and components (e.g., via a network, which may include the Internet, local network(s), and the like). As illustrated, the CPU 1105, memory 1110, storage 1115, network interface(s) 1125, and I/O interface(s) 1120 are communicatively coupled by one or more buses 1130.

In the illustrated embodiment, the memory 1110 includes a payment processing component 1150, an encryption/decryption component 1155, a message format transformation component 1160, and a light modulation component 1165. Although depicted as discrete components for conceptual clarity, in some embodiments, the operations of the depicted components (and others not illustrated) may be combined or distributed across any number of components. Further, although depicted as software residing in memory 1110, in some embodiments, the operations of the depicted components (and others not illustrated) may be implemented using hardware, software, or a combination of hardware and software.

The payment processing component 1150 manages payment transaction. In some embodiments, the payment processing component 1150 may communicate the payment details to a payment gateway (e.g., 280 of FIG. 2), where the data is executed. Based on the validation result, the payment processing component 1150 may generate a payment acknowledgment, indicating either the success or failure of the transaction. The encryption/decryption component 1155 includes encryption/decryption algorithms and works with hardware-based modules (e.g., HSM) to decrypt received payment data from the vehicle for validation and/or encrypt the acknowledgment message before transmission back to the vehicle. The message format transformation component 1160 manages the communication between the service station and the vehicle. In some embodiments, the message format transformation component 1160 may use the generative AI model to transform outgoing data to match the identified Li-Fi protocol, and transform received data into a format that is compatible with the service station's payment processing system. The light modulation component 1165 decodes the modulated light signals received from the vehicle, converting light signals into readable payment transaction data. After the payment data is executed by the payment gateway, the light modulation component 1165 encodes payment acknowledgment into modulated lights for transmission back to the vehicle.

While the foregoing is directed to embodiments of the present disclosure, other and further embodiments of the disclosure may be devised without departing from the basic scope thereof, and the scope thereof is determined by the claims that follow.

1. A computer-implemented method, comprising:
activating a Light Fidelity (Li-Fi) payment assistant unit of a vehicle in response to a user input;
receiving payment transaction information via an input device within the vehicle;
encrypting the payment transaction information;
transforming, using a vehicle-specific Li-Fi payment model, the encrypted payment transaction information from a payment message format to a Li-Fi protocol format supported by a service station, wherein the Li-Fi protocol format is configured for transmission of data using visible light as a communication channel;
encoding the transformed payment transaction information into a visible light signal by modulating visible light emitted from one or more light sources of the vehicle, comprising:
adjusting an intensity or frequency of the visible light to embed the transformed payment transaction information into the visible light signal; and
transmitting the visible light signal to a receiver of the service station.

2. The computer-implemented method of claim 1, further comprising:
receiving a second visible light signal comprising an encrypted payment acknowledgement from the service station;
transforming the encrypted payment acknowledgement from the Li-Fi protocol format into the payment message format;
decrypting the encrypted payment acknowledgement to retrieve payment status information;
presenting the payment status information via a user interface within the vehicle; and
deactivating the Li-Fi payment assistant unit in response to a second user input or a completion of payment.

3. The computer-implemented method of claim 2, wherein the payment status information is presented as a voice output, a text output, or a combination thereof.

4. The computer-implemented method of claim 1, wherein encrypting the payment transaction information is performed using a hardware-based encryption module and an encryption algorithm.

5. The method of claim 1, wherein the input device is selected from the group consisting of a fingerprint scanner, a camera with facial recognition functionality, or a card-based reader.

6. The method of claim 1, wherein the one or more light sources of the vehicle are selected from the group consisting of a headlight of the vehicle, a daytime running light (DRL) of the vehicle, or a fog light of the vehicle.

7. The method of claim 1, further comprising:
integrating a foundation model into the Li-Fi payment assistant unit of the vehicle;
generating the vehicle-specific Li-Fi payment model by fine-tuning the foundation model to accommodate one or more vehicle-specific requirements;
applying the vehicle-specific Li-Fi payment model to identify a Li-Fi protocol used by the service station for communication;
refining the vehicle-specific Li-Fi payment model using data related to the identified Li-Fi protocol; and
applying the refined vehicle-specific Li-Fi payment model to transform the encrypted payment transaction information from a payment message format to the Li-Fi protocol format.

8. A computer-implemented method, comprising:
receiving, by a Light Fidelity (Li-Fi) payment assistant unit of a service station, a visible light signal comprising a payment message from a vehicle;
decoding the visible light signal to recover the payment message in a Li-Fi protocol format;
transforming, using a station-specific Li-Fi payment model, the payment message from the Li-Fi protocol format to a payment message format, wherein the Li-Fi protocol format is supported by a service station and configured for transmission of data using visible light as a communication channel;
decrypting the payment message to retrieve payment transaction information;
executing the payment transaction information by communicating with one or more external networks via a payment gateway; and
generating a payment acknowledgment based on a result of the execution.

9. The method of claim 8, further comprising:
encrypting the payment acknowledgment;
transforming the encrypted payment acknowledgment into the Li-Fi protocol format;
encoding the payment acknowledgment into a second visible light signal by modulating light emitted from one or more light sources of the service station; and
transmitting the second visible light signal containing the payment acknowledgment to the vehicle.

10. The method of claim 8, further comprising transmitting the payment acknowledgment to a user interface of the service station via a wired or wireless link.

11. The method of claim 10, wherein the payment acknowledgment comprises payment status information, and wherein the payment status information is presented via the user interface as a voice output, a text output, or a combination thereof.

12. The method of claim 8, wherein decrypting the payment message to retrieve the payment transaction information is performed using a hardware-based encryption module and a decryption algorithm.

13. The method of claim 8, further comprising:
integrating a foundation model into the Li-Fi payment assistant unit of the service station;
generating the station-specific Li-Fi payment model by fine-tuning the foundation model to accommodate one or more station-specific requirements;
refining the station-specific Li-Fi payment model using data related to a Li-Fi protocol used by the service station for communication; and
applying the refined station-specific Li-Fi payment model to transform the payment message from the Li-Fi protocol format to a payment message format.

14. A system, comprising:
one or more processors;
one or more memories storing a program, which, when executed on any combination of the one or more processors, performs operations, the operations comprising:
activating a Light Fidelity (Li-Fi) payment assistant unit of a vehicle in response to a user input;
receiving payment transaction information via an input device within the vehicle;
encrypting the payment transaction information;
transforming, using a vehicle-specific Li-Fi payment model, the encrypted payment transaction information from a payment message format to a Li-Fi protocol format supported by a service station, wherein the Li-Fi protocol format is configured for transmission of data using visible light as a communication channel;
encoding the transformed payment transaction information into a visible light signal by modulating visible light emitted from one or more light sources of the vehicle, comprising:
adjusting an intensity or frequency of the visible light to embed the transformed payment transaction information into the visible light signal; and
transmitting the visible light signal to a receiver of the service station.

15. The system of claim 14, wherein the operations further comprising:
receiving a second visible light signal containing comprising an encrypted payment acknowledgement from the service station;
transforming the encrypted payment acknowledgement from the Li-Fi protocol format into the payment message format;
decrypting the encrypted payment acknowledgement to retrieve payment status information;
presenting the payment status information via a user interface within the vehicle; and the payment status information via a user interface within the vehicle; and
deactivating the Li-Fi payment assistant unit in response to a second user input or a completion of payment.

16. The system of claim 15, wherein the payment status information is presented as a voice output, a text output, or a combination thereof.

17. The system of claim 14, wherein encrypting the payment transaction information is performed using a hardware-based encryption module and an encryption algorithm.

18. The system of claim 14, wherein the input device is selected from the group consisting of a fingerprint scanner, a camera with facial recognition functionality, or a card-based reader.

19. The system of claim 14, wherein the one or more light sources of the vehicle are selected from the group consisting of a headlight of the vehicle, a daytime running light (DRL) of the vehicle, or a fog light of the vehicle.

20. The system of claim 14, wherein the operations further comprising:
integrating a foundation model into the Li-Fi payment assistant unit of the vehicle;
generating the vehicle-specific Li-Fi payment model by fine-tuning the foundation model to accommodate one or more vehicle-specific requirements;
applying the vehicle-specific Li-Fi payment model to identify a Li-Fi protocol used by the service station for communication;
refining the vehicle-specific Li-Fi payment model using data related to the identified Li-Fi protocol; and
applying the refined vehicle-specific Li-Fi payment model to transform the encrypted payment transaction information from a payment message format to the Li-Fi protocol format.
